(19) United States
(12) Patent Application Publication
(10) Pub. No.: US 2010/0225671 A1
(43) Pub. Date: Sep. 9, 2010

(54) METHOD FOR DRIVING PLASMA DISPLAY PANEL AND PLASMA DISPLAY DEVICE

(76) Inventors: Hiroyasu Makino, Osaka (JP); Toshikazu Wakabayashi, Osaka (JP); Seiji Minami, Hyogo (JP)

Correspondence Address: SNELL & WILMER L.L.P. (Panasonic), 600 ANTON BOULEVARD, SUITE 1400, COSTA MESA, CA, 92626, US

(21) Appl. No.: 12/376,433

(22) PCT Filed: Jan. 21, 2008
(86) PCT No.: PCT/JP2008/050731

§ 371 Date: Feb. 4, 2009

(30) Foreign Application Priority Data
Apr. 25, 2007 (JP) 2007 116030

(51) Int. Cl. G09G 5/10; G09G 3/28

(52) U.S. Cl. 345/690; 345/63

(57) ABSTRACT

The present invention aims to improve a low gradation expression ability by reducing the brightness of the 1^{st} gradation level to about 1.05 cd/m² of the intermediate brightness between the 0^{th} gradation level and the 2^{nd} gradation level at the time of driving a PDP. During a sustain erase period (P13) of a subfield (SF1) with the smallest brightness weight among a plurality of subfields (SF), a positive voltage (Vbk) that is smaller than a voltage (Vsus) applied during a sustain period (P23) of other SFs is applied to scan electrodes. Also, during the sustain erase period (P13) of SF1, a positive voltage (Vda) is applied to address electrodes or a positive voltage (Vda) is applied to the address electrodes during at least one period of a voltage rising period (T11) of an all-cell reset period (P11).

### TECHNICAL FIELD

The present invention relates to a driving method for a plasma display panel and a plasma display panel device.

### BACKGROUND ART

In plasma display devices, a scan electrode drive circuit, a sustain electrode drive circuit, and an address electrode drive circuit are connected to a plasma display panel (PDP) composed of an image display area in which first electrodes as scan electrodes, second electrodes as sustain electrodes, and third electrodes as address electrodes are provided. These drive circuits apply voltages to the electrodes to generate a gas discharge in each discharge cell and, with use of ultraviolet rays generated by the discharge, excite phosphors in respective colors of red, green, and blue to emit light, thereby performing color display.

Originally, each discharge cell in a PDP basically can only express two gradations that are lighting and non-lighting. Therefore, in order to perform multi-gradation display, a subfield method that temporally divides lightning times is employed. In other words, a PDP uses a drive method in which one TV field is divided into a plurality of subfields (SF), and cells in red, green, and blue express gradation levels according to combinations of the subfields.

According to this drive method, for example, one TV field is composed of eight SFs, and a relative brightness ratio is weighted in an ascending order in a binary mode such as 1, 2, 4, 8, 16, 32, 64, and 128. Combinations of these 8-bit weights can express 256 gradation levels (0^{th} gradation level to 255^{th} gradation level) in total.

Each SF is composed of a reset period, an address period, a sustain period, and an erase period in the stated order.

In the reset period, a reset discharge is generated in the discharge cells to erase the history of a wall charge accumulated in each discharge cell and form a wall charge required for a subsequent address operation. It should be noted that there are two kinds of resets, which are an all-cell reset and a selective reset: the all-cell reset generates a reset discharge in all of the discharge cells collectively by applying a rising ramp waveform to the scan electrodes; and the selective reset selectively generates a reset discharge in discharge cells which were lit in the SF before the reset.

In the address period, a scan pulse is applied to the scan electrodes sequentially, and an address pulse is selectively applied to address electrodes corresponding to image signals to be displayed. Consequently, an address discharge is selectively generated between the scan electrodes and the address electrodes, which leads to an address discharge between the scan electrodes and the sustain electrodes, forming a wall charge required for a sustain discharge.

In the sustain period, a sustain pulsed is applied between the scan electrodes and the sustain electrodes a predetermined number of times to selectively generate a sustain discharge in the discharge cells in which a wall charge was formed due to the address discharge, thereby sustaining a light emission of these cells.

The number of sustain pulses applied in the sustain period of each SF is set to a number which is approximately proportionate to the above-described weight and which can secure sufficient light, such as, 2, 4, 8, 16, 32, 64, 128, or 256.

In the erase period, the sustain discharge being generated is terminated to decrease a wall charge which was excessively accumulated in the discharge cells due to repeating sustain discharges in the sustain period. That is to say, by preventing a wall charge from being excessively accumulated in the discharge cells before entering the next SF, an excessive reset discharge in the selective reset in the next SF can be suppressed, thereby suppressing false discharges (a crosstalk and the like) during the address discharge. It should be noted that the erase period is provided with an aim of increasing an operation margin of the PDP, and thus is not always required.

This is how display of one SF is performed in these periods. Meanwhile, in discharge cells where display was not performed, the address discharge, the sustain discharge and the erase discharge were not generated, resulting in the wall charge accumulated by the reset discharge being maintained. Similar operations are performed in the respective periods in each SF in one TV field to display one screen.

Generally, in order for displays to achieve smooth expression in low gradation levels, it is considered effective to display in a way that the relative brightness ratio becomes smaller as the gradation level becomes lower. However, for plasma display devices (hereinafter, referred to as “PDP devices”), it is difficult to reduce the relative brightness ratio in low gradation levels, and accordingly, it is difficult to achieve smooth expression in low gradation levels.

For example, in CRTs, a brightness difference between the 0^{th} gradation level and the 1^{st} gradation level among the total of 256 gradation levels is small, thereby allowing smooth gradation display (“0^{th} gradation level”, “1^{st} gradation level”, “2^{nd} gradation level” and the like refer to gradations among the 256 gradation levels.) Meanwhile, in PDP devices, because brightness of the 1^{st} gradation level is comparatively large, a brightness difference between the 0^{th} gradation level and the 1^{st} gradation level is larger than that of CRTs. As a result, unlike CRTs, it is difficult for PDPs to express brightness variation smoothly. Additionally, because a peak brightness of PDPs is low in the first place, a virtual gradation display using error diffusion processing (dither method) accentuates roughness due to error diffusion noises in an image, deteriorating the image on the contrary as a result of being unable to achieve an error diffusion effect.

In view of such a problem, Patent Document 1 discloses a technique in which the number of sustain pulses for the 1^{st} gradation level is reduced to once from twice which is the conventional number, thereby reducing the brightness of the 1^{st} gradation level.

Patent Document 1: Japanese Laid-Open Patent Application Publication No. 2002-014652

### DISCLOSURE OF THE INVENTION

### Problems the Invention is Going to Solve

Reducing the number of pulses for the 1^{st} gradation level as disclosed by Patent Document 1 can lower the brightness of the 1^{st} gradation level, improving expressiveness in low gradation levels. However, according to this technique, the brightness of the 1^{st} gradation level is 1.55 cd/m² while the brightness of the 0^{th} gradation level is 0.23 cd/m², indicating m² between the 0^{th} and 1^{st} a brightness difference of 1.32 cd/gradation levels. Compared to CRTs, this brightness difference is still considerably large, and needs to be improved to express brightness variation smoothly.

Further, in order to improve the expressiveness in low gradation levels of a PDP, a brightness balance between adjacent gradation levels, in addition to the reduction of the brightness of the 1^{st} gradation level, is important. Specifically, the brightness of the 2^{nd} gradation level is 1.88 cd/m², and taking the brightness balance between adjacent gradation levels into consideration, it is preferable that the brightness of the 1^{st} gradation level be approximately an intermediate brightness between the 0^{th} and 2^{nd} gradation levels (1.88−0.23)/2+0.23=1.55 cd/m²). However, when the brightness of the 1^{st} gradation level is 1.55 cd/m², the brightness difference between the 1^{st} and 2^{nd} gradation levels is only 0.33 cd/m², which is out of brightness balance considering the brightness difference of 1.32 cd/m² between the 0^{th} and 1^{st} gradation levels.

It should be noted that while the above brightnesses are numeric values in cases of PDPs with an Xe ratio of 6%, the relationship in terms of gradation balance is the same in PDPs and high-definition PDPs whose partial pressure of Xe in the discharge gas is high.

In view of such a problem, one possible solution is to weaken the intensity of the sustain discharge to reduce the brightness of the 1^{st} gradation level by rendering the voltage applied to the scan electrodes in the sustain period lower than the voltage applied for the 2^{nd} and higher gradation levels. However, if the applied voltage is lowered to the point at which the brightness is 1.28 cd/m², a discharge delay of the sustain discharge increases, causing an insufficient sustain discharge. This results in phenomenon in which a weak discharge develops into a strong discharge (reset discharge error) in a rising ramp waveform in the next all-cell reset period. As a result, the brightness increases, and in addition, false discharges occur in the following address period, impairing the image quality with flicker and roughness in an image.

The present invention was conceived in view of the above problems and aims to improve expressiveness in low gradation levels when driving a PDP by lowering the brightness of the 1^{st} gradation level down to approximately 1.05 cd/m² which is the intermediate brightness between the 0^{th} and 2^{nd} gradation levels.

### Means of Solving the Problems

In order to achieve the stated aim, according to the present invention, when driving a PDP, one TV field (i) is composed of a plurality of subfields each including a reset period in which a reset discharge is generated in the discharge cells, an address period in which an address discharge is generated in discharge cells to be lit, and a sustain period in which a sustain discharge is generated in the discharge cells in which the address discharge was generated and (ii) includes at least one all-cell reset period including a voltage (potential) rising period in which a voltage (potential) of the first electrodes rises in a ramp shape at a voltage gradient of 10 V/μs or less, and the present invention further includes the following features.

A feature A: in a sustain period of a subfield with the smallest brightness weight (SF1), a positive voltage pulse is applied to the first electrodes, the positive voltage pulse having an amplitude smaller than a voltage applied to the first electrodes in a sustain period of any SF other than SF1.

The present invention includes the feature A, and in addition, includes one or both of a feature B and a feature C.

The feature B: a positive voltage is applied to the third electrodes in the sustain period of SF1.

The feature C: a positive voltage is applied to the third electrodes in at least part of the voltage rising period.

In the above-described invention, it is preferable that an all-cell reset period be provided in SF2 which immediately follows SF1.

Also, it is preferable that the present invention be also constructed as follows.

As a reset of SF2 after SF1, a selective reset is performed, and subsequently, an all-cell reset is performed, the selective reset including a voltage (potential) falling period in which the voltage of the first electrodes falls in a ramp shape at a voltage gradient of 10 V/μs or less.

The most negative voltage (potential) applied to the first electrodes in the selective reset period of SF2 is lower than a voltage applied to the first electrodes in a selective reset period of any SF other than SF2.

The most positive voltage (potential) applied to the second electrodes in the selective reset period of SF2 is higher than a voltage applied to the second electrodes in a selective reset period of any of other SFs.

A negative voltage is applied to the second electrodes in the sustain period in SF1.

A negative voltage is applied to the second electrodes in the rising waveform part in the all-cell reset period.

The voltage applied to the third electrodes in the sustain period of SF1 is higher than a voltage applied to the third electrodes in the address period of SF1.

A negative voltage is applied to the second electrodes in the voltage rising period of the all-cell reset period.

The voltage applied to the third electrodes in the voltage rising period of the all-cell reset period is higher than a voltage applied to the third electrodes in the address period of SF including the voltage rising period.

An average brightness level of image data is detected for each TV field, and a magnitude of the positive voltage applied to the first electrodes in the sustain period of SF1 is adjusted based on the detected average brightness level.

The positive voltage applied to the first electrodes in the sustain period of SF1 is in a range of 90 V to 180 V, inclusive.

The positive voltage applied to the third electrodes is in a range of 15 V to 150 V, inclusive.

The positive voltage applied to the first electrodes in the sustain period of SF1 is in a range of 50% to 100%, inclusive, of the voltage applied to the first electrodes in the sustain period of any other SFs.

### EFFECTS OF THE INVENTION

According to the present invention, one TV field is composed of a plurality of subfields (SF) and a voltage to the first electrodes in a sustain period of the subfield (SF1) having the smallest brightness weight is smaller than in a sustain period of any SF other than SF1 (feature A) so as to weaken an intensity of a sustain discharge. Accordingly, the light emission brightness in SF1 can be suppressed, thereby lowering the brightness of the 1^{st} gradation level.

When the voltage applied to the first electrodes in the sustain period is set to be small, as described above, a discharge delay increases in general, hindering a sufficient sustain discharge, and an insufficient sustain discharge in SF1 is likely to cause a reset discharge error in the all-cell reset period. In view of this, the present invention includes one or both of the features B and C described in “Means of Solving the Problems”, allowing a stable reset discharge in the all-cell reset period as a result.

That is to say, the application of a positive voltage to the third electrodes in the sustain period of SF1 (feature B) facilitates extraction of electrons from the surface of the protective layer of the front panel; Consequently, even if the voltage applied to the first electrodes is rendered smaller, the sustain discharge can still be performed stably. As a result, the reset discharge can be performed stably in the all-cell reset period.

Also, the application of a positive voltage to the third electrodes in at least part of the voltage rising period of the all-cell reset period (feature C) prevents start of a reset discharge between the first and third electrodes. Consequently, even if the sustain discharge in the previous SF is insufficient, a stable reset discharge can still be performed.

Although performing one of the features B and C is effective in suppressing reset errors, as described above, performing both of the features B and C can achieve an synergetic effect.

Thus, by including two or more of the above-mentioned features (A, B, C), an stable reset discharge can be performed even in the case where the voltage applied to the first electrodes in the sustain period of SF1 is set to be further smaller.

Thus, the present invention can achieve an excellent display performance in low gradation levels while also performing stable gradation display.

Additionally, performing an all-cell reset period in the reset period of SF2 following SF1 improves stability of the address discharge in SF2.

That is to say, because the sustain discharge is generated only once in SF1, no erase discharge can be generated. Accordingly, a wall charge tends to be excessively accumulated in discharge cells. As a result, an excessively accumulated wall charge exists between the first and second electrodes after the selective reset in SF2, which may cause false discharge (crosstalk, etc.) in the address period. However, performing the all-cell reset immediately after SF1, as described above, can adjust the accumulated wall charge to an appropriate state, and accordingly, the address discharge can be stably performed in SF2.

Furthermore, performing the selective reset prior to the all-cell reset in the reset period of SF2 can suppress variations in the accumulated wall charges between the discharge cells which had an address discharge in SF1 and the discharge cells which did not have an address discharge in SF1. Consequently, the all-cell reset can be uniformly performed in all the discharge cells.

Also, when the selective reset is performed prior to the all-cell reset in the reset period of SF2, if the voltage applied to the first electrodes in the selective reset is lower than the voltage applied to the first electrodes in other SFs, the voltage difference (potential difference) between the first and second electrodes increases, facilitating a reset discharge between the first and second electrodes. This leads to a satisfactory all-cell reset, and further to a satisfactory address discharge.

Also, when the voltage applied to the second electrodes in the selective reset period of SF2 is set higher than the voltage applied to the second electrodes in other SFs, the voltage difference between the first and second electrodes further increases. This further, facilitates the performance of the reset discharge, and facilitates a more satisfactory address discharge.

Additionally, when a negative voltage is applied to the second electrodes in the sustain period of SF1, the sustain discharge can be generated satisfactorily even in the case where the voltage applied to the first electrodes is kept low.

Likewise, when a voltage applied to the third electrodes in the sustain period of SF1 is higher than a voltage applied to the third electrodes in other SFs, the sustain discharge can be performed satisfactorily.

In addition, when the most negative voltage applied to the first electrodes in the selective reset period of SF2 is lower than a voltage applied to the first electrodes in a selective reset period of other SFs or when the most positive voltage applied to the second electrodes in the selective reset period of SF2 is higher than a voltage applied to the second electrodes in a selective reset period of other SFs, the accumulated wall charges in the discharge cells which had an address discharge in SF1 and in the discharge cells which did not have an address discharge in SF1 can be further equalized. Consequently, amore satisfactory reset discharge is performed in the next all-cell reset.

Further, if a negative voltage is applied to the second electrodes or a positive voltage applied to the third electrodes is higher, electrodes are easily extracted from the surface of the protective layer, improving the reliability of the reset discharge.

It is favorable that the voltage applied to the first electrodes in the sustain period of SF1 be in a range of 90 V or higher and 180 V or lower. The voltage set to this range is suitable for achieving the brightness of 1.55 cd/m² or lower in SF1, and in addition, can suppress reset errors.

### BRIEF DESCRIPTION OF THE DRAWINGS

FIG. 1 is a cross-sectional perspective view of a structure of a PDP of embodiments;

FIG. 2 shows a structure of a drive unit which drives the PDP of the embodiments;

FIG. 3 shows drive voltage waveforms applied to electrodes of the PDP by drive circuits of a first embodiment;

FIG. 4 shows a scan electrode drive circuit of the first embodiment;

FIG. 5 shows a first modification of the scan electrode drive circuit of the first embodiment;

FIG. 6 shows a second modification of the scan electrode drive circuit of the first embodiment;

FIG. 7 shows a sustain electrode drive circuit of the first embodiment;

FIG. 8 shows an address electrode drive circuit of the first embodiment;

FIG. 9 shows ON/OFF states of switching elements of the drive circuits of the first embodiment;

FIG. 10 shows drive voltage waveforms applied to the electrodes of the PDP by drive circuits of a second embodiment;

FIG. 11 shows drive voltage waveforms applied to the electrodes of the PDP by drive circuits of a third embodiment;

FIG. 12 shows drive voltage waveforms applied to the electrodes of the PDP by drive circuits of a fourth embodiment;

FIG. 13 shows drive voltage waveforms applied to the electrodes of the PDP by drive circuits of a fifth embodiment;

FIG. 14 is a graph showing a result of an experiment using the drive voltage waveforms of the fifth embodiment;

FIG. 15 shows drive voltage waveforms applied to the electrodes of the PDP by drive circuits of a sixth embodiment; and

FIG. 16 shows drive voltage waveforms applied to the electrodes of the PDP by drive circuits of a seventh embodiment.

### DESCRIPTION OF REFERENCE NUMERALS

1 PDP
PA1 Front panel
PA2 Back panel
18 Protective layer
19a Scan electrode
19b Sustain electrode
14 Address electrode
20 Discharge space
21 Scan electrode drive circuit
22 Sustain electrode drive circuit
23 Address electrode drive circuit
24 Timing generation unit

### BEST MODE FOR CARRYING OUT THE INVENTION

The following describes an AC-type PDP device embodying features of the present invention, with reference to the drawings.

### First Embodiment

### <Overall Structure of PDP Device>

The PDP device includes a PDP and a drive unit.

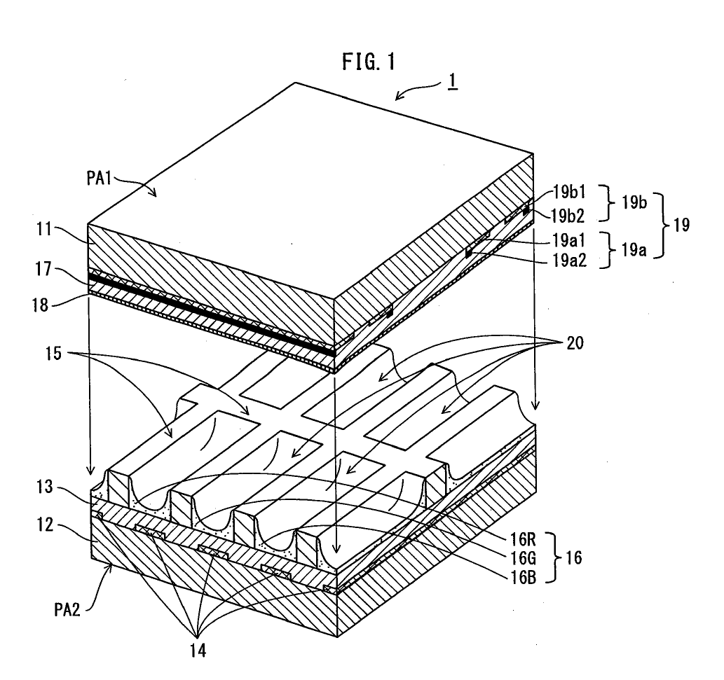

FIG. 1 shows a structure of a PDP 1 of the present embodiment.

The PDP 1 is composed of a front panel PA1 and a back panel PA2 opposing each other.

The front panel PA1 includes a front glass substrate 11 on which display electrode pairs 19 each composed of a scan electrode 19a as a first electrode and a sustain electrode 19b as a second electrode are formed in a stripe pattern, and a dielectric layer 17 and a protective layer 18 are formed to cover the scan electrodes 19a and the sustain electrodes 19b. Each scan electrode 19a is made up of a transparent electrode 19a1 and a metal electrode 19a2, and similarly, each sustain electrode 19b is made up of a transparent electrode 19b1 and a metal electrode 19b2.

The back panel PA2 includes a back glass substrate 12 on which a plurality of address electrodes 14 as third electrodes are formed in a stripe pattern, a dielectric layer 13 is formed to cover the address electrodes 14, and barrier ribs 15 are formed on the dielectric layer 13.

The address electrode pairs 19 and address electrodes 14 spatially intersect each other, forming a discharge cell at each intersecting part.

The barrier ribs 15 are formed in a grid pattern and separate discharge spaces 20. Inner surfaces of the barrier ribs 15 and a surface of the dielectric layer 13 that face each discharge space 20 are coated with one of a red phosphor layer 16R, a green phosphor layer 16G, and a blue phosphor layer 16B.

Note that each discharge space 20 is filled with a discharge gas.

A drive unit connected to the PDP 1 includes a scan electrode drive circuit driving the scan electrodes 19a, a sustain electrode drive circuit driving the sustain electrodes 19b, and an address electrode drive circuit driving the address electrodes 14. Ultraviolet rays are generated by a gas discharge in each discharge space 20 due to a voltage application to the scan electrodes 19a, sustain electrodes 19b, and address electrodes 14 by these drive circuits. These ultraviolet rays excite the phosphor layers 16 in the colors of red, green, and blue to emit light so as to perform color display.

### <Structure of Drive Unit>

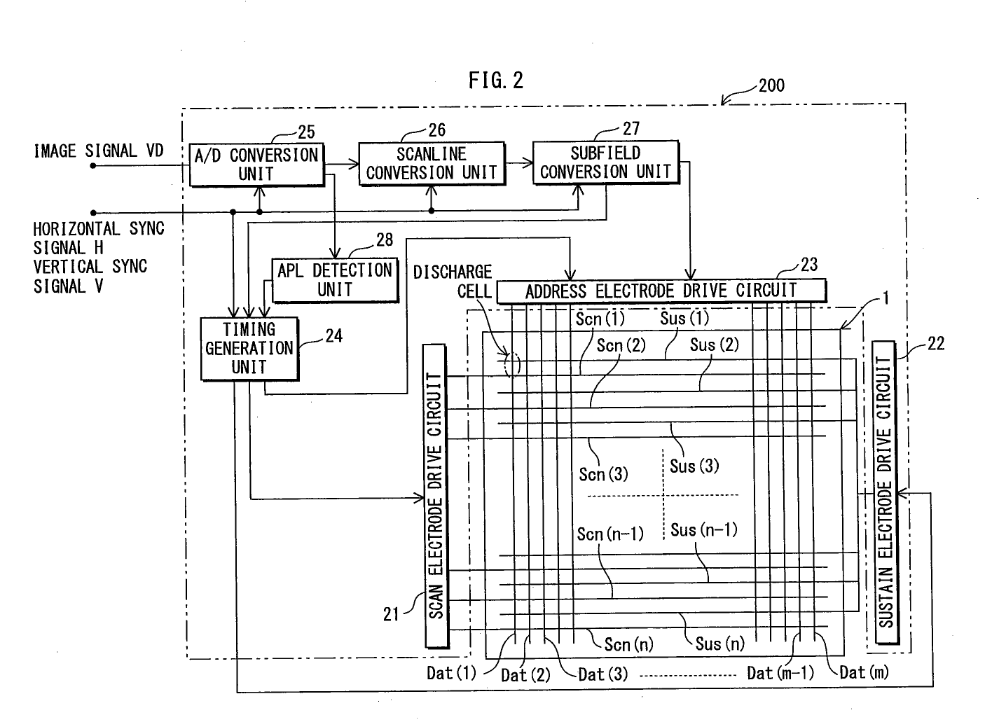

The structure of the drive unit is described with reference to FIG. 2. showing the structure of the drive unit 200 which drives the PDP 1.

The drive unit 200 includes a scan electrode drive circuit 21, a sustain electrode drive circuit 22, address electrode drive circuit 23, a timing generation unit 24, an A/D (Analog/Digital) conversion unit 25, a scanline conversion unit 26, a subfield conversion unit 27, an APL (Averaged Picture Level) detection unit 28 and the like.

In the drive unit 200, an image signal VD is input to the A/D conversion unit 25, and a horizontal sync signal H and a vertical sync signal V are input to the A/D conversion unit 25, the scanline conversion unit 26, and the subfield conversion unit 27. The vertical sync signal V is also input to the timing generation unit 24.

The A/D conversion unit 25 converts the input image signal VD into a digital signal representing image data, and outputs the converted image data to the scanline conversion unit 26 and the APL detection unit 28.

The scanline conversion unit 26 converts the image data received from the A/D conversion unit 25 into image data corresponding to a number of pixels of the PDP 1, and outputs the converted image data to the subfield conversion unit 27. The subfield conversion unit 27 which has a subfield memory (not depicted) converts the image data transferred from the scanline conversion unit 26 into subfield data and temporarily stores the subfield data in the subfield memory. The subfield data is a set of pieces of binary data indicating ON/OFF of a set of subfields with respect to each discharge cell and used for grayscale display in the PDP 1. Note that the subfield conversion unit 27 then outputs the subfield data stored in the subfield memory to the address electrode drive circuit 23 in accordance with a timing signal received from the timing generation unit 24.

The APL detection unit 28 detects an average brightness level of image data for each TV field. The drive unit controls drive waveforms based on the average brightness level detected by the APL detection unit 28.

The timing generation unit 24 generates a field starting signal after a certain period of time from the input of the vertical synchronization signal V. Then, the timing generation unit 24 generates a timing signal for instructing a start of an initialization period, a writing period, and a sustain period of each subfield based on this field starting signal. Also, the timing generation unit 24 counts clocks based on this timing signal to generate a timing signal for indicating a timing of pulse generation to each of the scan electrode drive circuit 21, the sustain electrode drive circuit 22, and the address electrode drive circuit 23. Then, the timing generation unit 24 outputs the various timing signals to each of the scan electrode drive circuit 21, sustain electrode drive circuit 22, and address electrode drive circuit 23.

Therefore, a setting time from a start of each subfield to a rising of each pulse and a setting time from a start of each subfield to a falling of each pulse are converted into the number of clocks and stored in the timing generation unit 24. At the same time of the start of the subfield, the timing generation unit 24 resets a time counter and indicates the pulse rising or the pulse falling to each of the scan electrode drive circuit 21, sustain electrode drive circuit 22, and address electrode drive circuit 23 when the time counter reaches each setting time.

The drive circuits 21 to 23 each are provided with a known driver IC and the like, and output drive voltage pulses, which are described later, to the PDP 1 in accordance with the timing signals transmitted from the timing generation unit 24.

The scan electrode drive circuit 21 applies a scan pulse, a sustain pulse and the like to the scan electrodes 19a in accordance with the timing signals transmitted from the timing generation unit 24. Note that the scan electrode drive circuit 21 is provided with a circuit able to output two kinds of sustain pulse voltages (potentials) (Vsus and Vbk) to the scan electrodes 19a.

The sustain electrode drive circuit 22 applies a sustain pulse and the like to the sustain electrodes 19b in accordance with the timing signals transmitted from the timing generation unit 24.

The address electrode drive circuit 23 includes address IC groups and in the address period, applies an address pulse to, among the plurality of address electrodes 14, address electrodes 14 selected based on the subfield data, in accordance with the timing signals transmitted from the timing generation unit 24.

### <Drive Voltage Waveforms Applied by Drive Circuits>

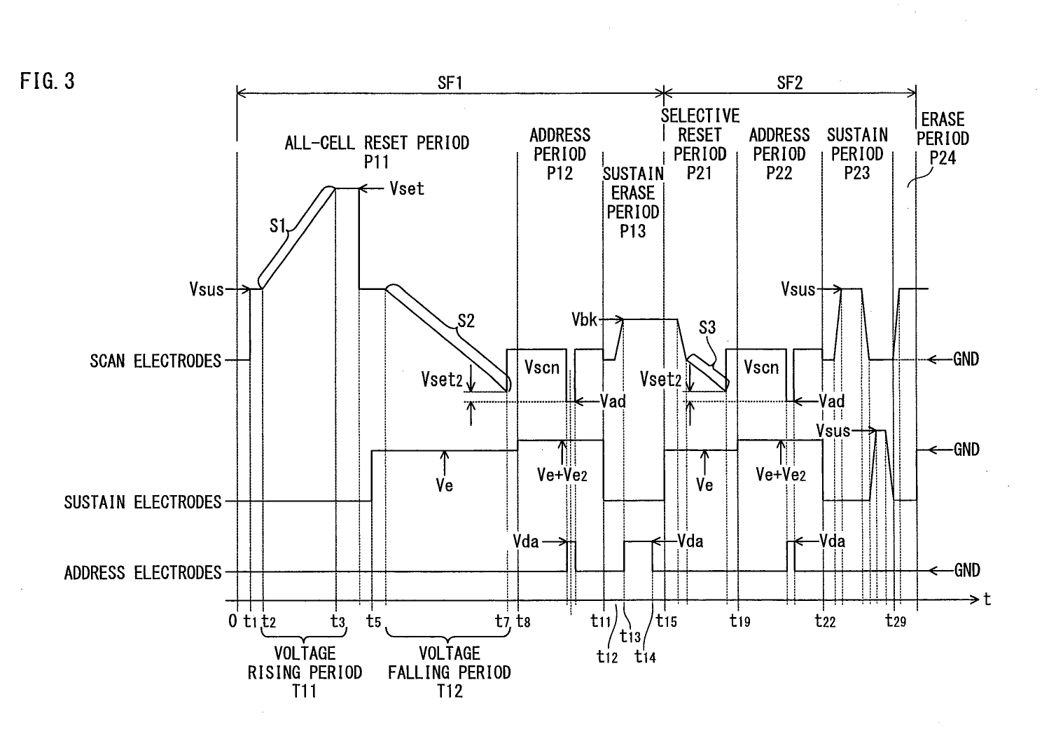

Next, description is given on drive voltage waveforms applied to the scan electrodes 19a, the sustain electrodes 19b, and the address electrodes 14 by the drive unit 200, with reference to FIG. 3.

FIG. 3 shows the drive voltage waveforms applied to the electrodes of the PDP in SF1 and SF2 by the drive circuits 21 to 23. Note that although FIG. 3 does not show SF3 and subsequent subfields, the waveforms in these subfields are the same as those in SF2 except for the number of sustain pulses.

SF1 includes an all-cell reset period P11, an address period P12, and a sustain erase period P13, while SF2 includes a selective reset period P21, an address period P22, a sustain period P23, and an erase period P24.

First, description is given on the drive voltage waveforms in each period.

### <All-Cell Reset Period P11>

In the all-cell reset period P11, a reset pulse which includes a rising ramp waveform (S1 part) and a falling ramp waveform (S2 part) is collectively applied to all of the scan electrodes to generate a weak discharge, thereby erasing the history of the wall charge accumulated in each discharge cell, and forming a wall charge required for the following address operation.

In the rising ramp waveform part S1, the electric voltage (potential) applied to the scan electrodes rises from a voltage (potential) Vsus(V) to the most positive voltage (potential) Vset(V) in a gentle positive slope (voltage gradient of 10 V/μs or less). Also, during a period (voltage (potential) rising period) T11 corresponding to the rising ramp waveform part S1, voltages (potentials) of the sustain electrode and address electrodes are maintained at the ground voltage (potential).

Consequently, in the voltage rising period T11, a voltage difference in each discharge space exceeds the firing voltage, generating a slight discharge (a weak discharge by which ionization temporally gently proceeds). As a result, an electric charge generated by the slight gas discharge is accumulated as a wall charge around the address electrodes, the scan electrodes, and the sustain electrodes in a wall surface surrounding the discharge space 20. Specifically, a negative charge is accumulated on a surface of the protection layer around the scan electrodes to weaken an electric field of each discharge space and surfaces of the electrodes, and a positive electric charge is accumulated on a surface of the protective layer 18 around the sustain electrodes and a surface of the phosphor layers around the address electrodes.

On the other hand, in the falling ramp waveform part S2, the electric voltage applied to the scan electrodes falls from the voltage Vsus(V) in a gentle negative slope (voltage gradient of 10 V/μs or less). Also, during a period (voltage (potential) falling period) T12 corresponding to the falling ramp waveform part S2, the voltage of the sustain electrodes are maintained at a voltage (potential) Ve(V).

Consequently, in the voltage falling period T12, the voltage of the scanning electrodes changes from positive to negative, and a weak discharge is generated. As a result, the state of the negative electric charge accumulated on the surface of the protective layer around the scan electrodes and the state of the positive electric charge accumulated on the surface of the protective layer around the sustain electrodes are adjusted to be uniform.

As mentioned above, in the all-cell reset period P11, all of the discharge cells are reset to a uniform state by the weak discharges in the voltage rising period T11 and the voltage falling period T12, and the wall voltage (potential) suitable for the address operation is formed between the scan electrodes, the address electrodes, and the sustain electrodes.

It should be noted that the waveforms in the all-cell reset period P11 are not limited to the above-described waveforms and can be any waveforms as long as they are able to achieve the state where the voltage difference between the scan electrodes and the address electrodes gently rises or falls and a weak discharge is generated continuously.

### <Address Period P12>

In the address period P12, a negative scan pulse voltage (potential) Vad(V) is applied to the scan electrodes and a positive address pulse voltage (potential) Vda(V) is selectively applied to the address electrodes corresponding to the discharge cells to be lit, while the voltage of the sustain electrodes is kept at a positive voltage (potential) Ve+Ve2(V). It should be noted that the scan pulse voltage Vad(V) applied to the scan electrodes is set to be lower by Vset2(V) than the most negative voltage applied in the voltage falling period T12 in the all-cell reset period P11. Also, since the voltage Ve2 applied to the sustain electrodes is smaller than the voltage Ve, the voltage of the sustain electrodes can be kept at Ve.

At the end of the all-cell reset period P11, the negative wall charge has been formed at the scan electrodes side, and the positive wall charge has been formed at the address electrodes side. As described above, by applying, to the scan electrodes, the sustain electrodes, and the address electrodes, a voltage that is of the same polarity as the wall charge formed at the scan electrodes, the sustain electrodes, and the address electrodes, respectively, address discharges are selectively generated between the scan electrodes and the address electrodes, which trigger address discharges between the scan electrodes and the sustain electrodes. In the discharge cells where an address discharge has been generated, a positive charge is accumulated on the surface of the protection layer around the scan electrodes, and a negative charge is accumulated on the surface of the phosphor layers and the surface of the protection layer around the sustain electrodes.

As a result, a wall discharge suitable for the next sustain discharge is formed between the scan electrodes and the sustain electrodes at the end of the address period P12.

### <Sustain Erase Period P13>

In the sustain erase period P13, a positive sustain pulse (voltage (potential) Vbk(V)) is applied to the scan electrodes once. Here, the voltage of the sustain electrodes is kept at the ground voltage, and the positive voltage Vda(V) is applied to the address electrodes since the positive sustain pulse is applied as above.

By performing the voltage applications to the respective electrodes as described above, a sustain discharge occurs in each of the discharge cells where the address discharge was generated during the address period P12, whereby a wall charge is formed in a manner that the voltage applied between the scan electrodes and the sustain electrodes is cancelled and the polarity of the wall discharge is reversed.

Next, description is given on drive voltage waveforms in each period in SF2, focusing on how they differ from the periods in SF1. Note that since the address period P22 is similar to the address period P12 of SF1, a description thereof is omitted.

### <Selective Reset Period P21>

As shown in FIG. 3, a selective reset pulse in the selective reset period P21 gradually slopes from the voltage Vbk(V) and includes a falling ramp waveform part S3 that falls at a voltage gradient of 10 V/μs or less.

This application of the selective reset pulse generates a weak discharge in each of the discharge cells in which the sustain discharge was generated in SF1. As a result, each wall charge on the scan electrode, the sustain electrode, and the address electrode in each discharge cell is adjusted to a range suitable for the address operation in SF2. On the other hand, the weak discharge does not occur in discharge cells in which the address discharge and the sustain discharge were not generated in SF1. Accordingly, the wall charges formed at the end of the all-cell reset period P11 of SF1 are maintained.

### <Sustain Period P23>

In the sustain period of SF2, a sustain pulse of a positive voltage (potential) Vsus(V) that is larger than the voltage Vbk(V) applied in the sustain erase period P13 of SF1 is applied to the sustain electrodes and the scan electrodes alternately. The sustain charge occurs in accordance with the number of times this sustain pulse is applied.

It should be noted that in the sustain periods of SF3 and the subsequent subfields, the sustain discharge is generated by applying the sustain pulse more often than in SF2.

### <Erase Period P24>

In SF2, after the final sustain pulse in the sustain period P23 is applied, an erase discharge is generated to break off the sustain charge. In the present embodiment, the erase discharge is realized by raising the voltage of the sustain electrodes immediately after raising the voltage of the scan electrodes, thereby adjusting the amount of the wall charge accumulated in the selective reset period of SF3 to the state suitable for the next address operation.

### <Drive Circuits for Forming Above-Described Drive Voltage Waveforms>

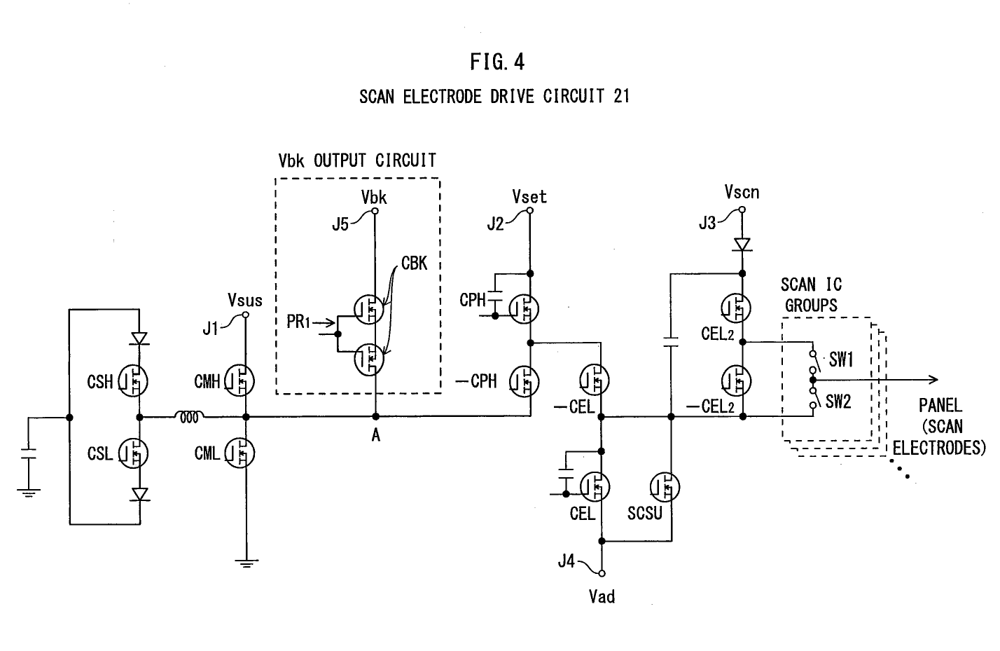

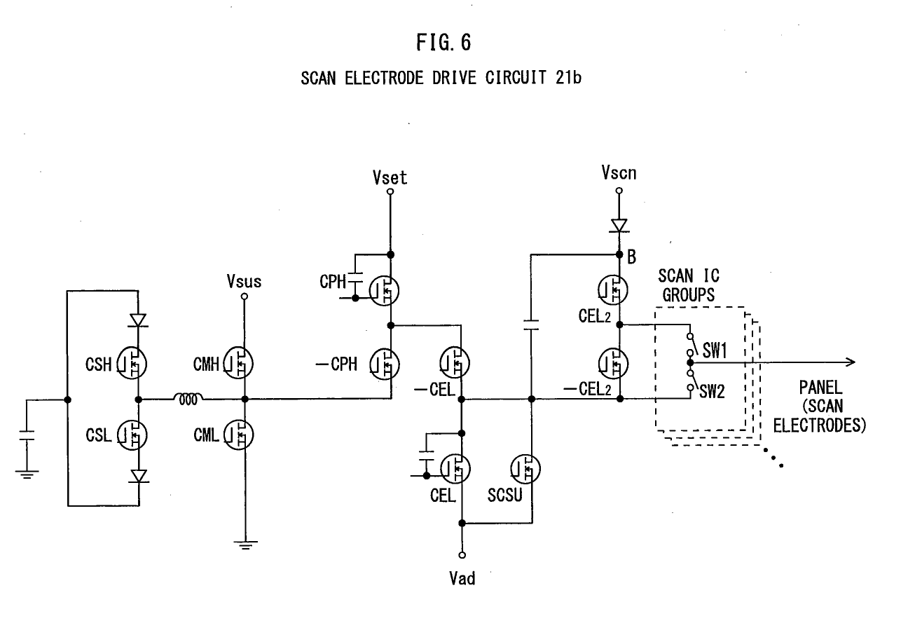

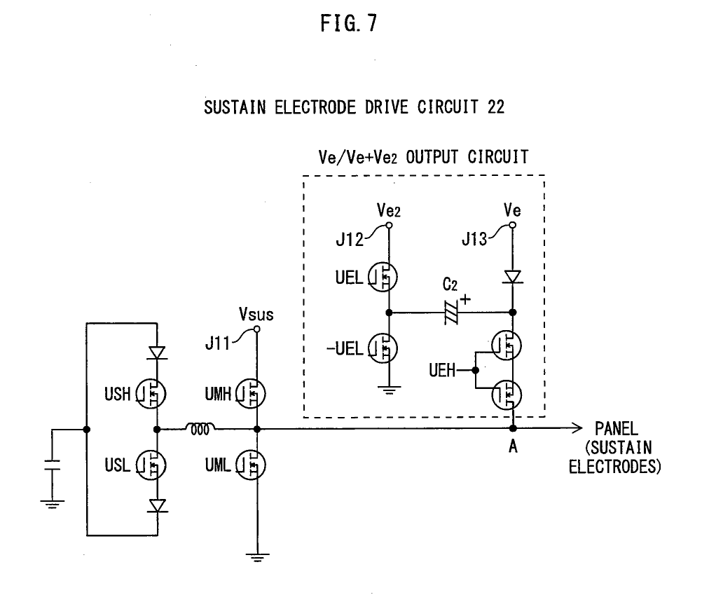

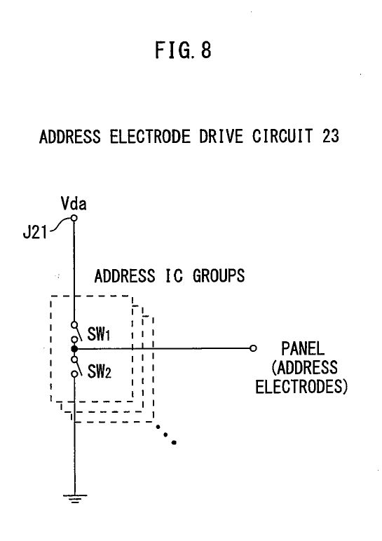

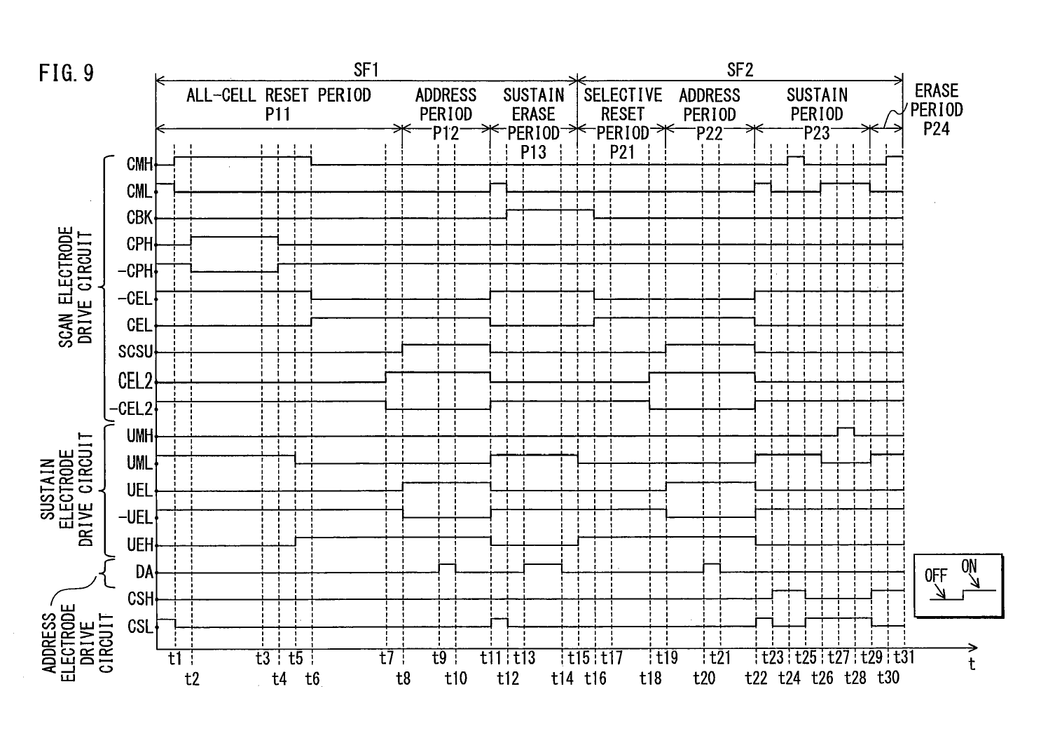

Described below are the drive circuits and operations thereof to realize the drive voltage waveforms shown in FIG. 3. Of the drive unit 200 shown in FIG. 2, a detailed structure of the scan electrode drive circuit 21 is shown in FIGS. 4 to 6, a detailed structure of the sustain electrode drive circuit 22 is shown in FIG. 7, and a detailed structure of the address electrode drive circuit 23 is shown in FIG. 8. Also, a timing chart indicating ON/OFF of switching elements in the drive circuits are shown in FIG. 9.

### <Scan Electrode Drive Circuit 21>

The scan electrode drive circuit 21 outputs an all-cell reset pulse (voltage Vset), scan pulses (voltage Vad, Vscn), a sustain pulse (voltage Vsus) in SF2 and subsequent subfields, and the sustain pulse (voltage Vbk) in SF1.

As output power supplies, a positive power supply (voltage Vsus) for the sustain pulse in SF2 and subsequent subfields; a positive power supply (voltage Vset) for the all-cell reset pulse, a positive power supply (voltage Vscn) and a negative power supply (voltage Vad) for the scan pulses, and a positive power supply (voltage Vbk) for the sustain pulse in SF1 are connected to input terminals J1 to J5, respectively. Switching elements CEL2, −CEL2, SCSU, . . . which are FETs (Field-Effect Transistors) are provided between the input terminals J1 to J5 and the scan IC groups, and each scan IC group has two switches SW1 and SW2 in a circuit thereof outputting to the scan electrodes. The drive voltage is controlled by controlling these switching elements CEL2, −CEL2, SCSU, . . . and the two switches SW1 and SW2.

The scan electrode drive circuit 21 applies the drive voltage to the scan electrodes of the PDP in SF1, SF2, SF3, . . . , while collecting reactive power in the sustain period. Note that circuits except a Vbk output circuit (dotted part) are conventionally used circuits, and detailed operations of the circuit 21 are described in International Application (Application Number: PCT/JP02/06180). Accordingly, a detailed description thereof is omitted here.

The following describes operations for outputting the drive voltage having the waveforms shown in FIG. 3. In the all-cell reset period P11 of SF1, the switching elements CPH and −CEL are turned ON in the voltage (potential) rising period (t2 to t3) T11 to raise the output voltage to Vset. In the voltage (potential) falling period (t6 to t7, t16 to t18) T12, the switching element CEL is turned ON to lower the output voltage to the most negative voltage that is larger than Vad only by the voltage Vset2(V).

Next, in the address period (t8 to t11) P12 of SF1, the switching elements SCSU and CEL2 are turned ON, and the switches SW1 and SW2 of the scan IC groups are controlled to output the voltage Vscn or the voltage Vad.

In the sustain erase period (t11 to t15) P13 of SF1, the switching element CBK is turned ON, while keeping the ON state of the switching elements −CPH and −CEL, to output the voltage Vbk.

In the selective reset period (t15 to t19) P21 of SF2, the output voltage (potential) is lowered as in the voltage falling period T12 in the all-cell reset period P11.

In the address period (t19 to t22) P22 of SF2, the switching elements SCSU and CEL2 and the two switches SW1 and SW2 are controlled as in the address period P12 of SF1.

In the sustain period (t22 to t29) of SF2, the switching elements −CPH and −CEL are turned ON, and CMH and CML and controlled to output the voltage Vsus or the ground voltage (potential). Here, the switching element −CEL2 can be turned ON to protect the scan IC groups from a noise due to overvoltage.

This is how the pulse having the drive voltage waveform shown in FIG. 3 is applied to the scan electrodes.

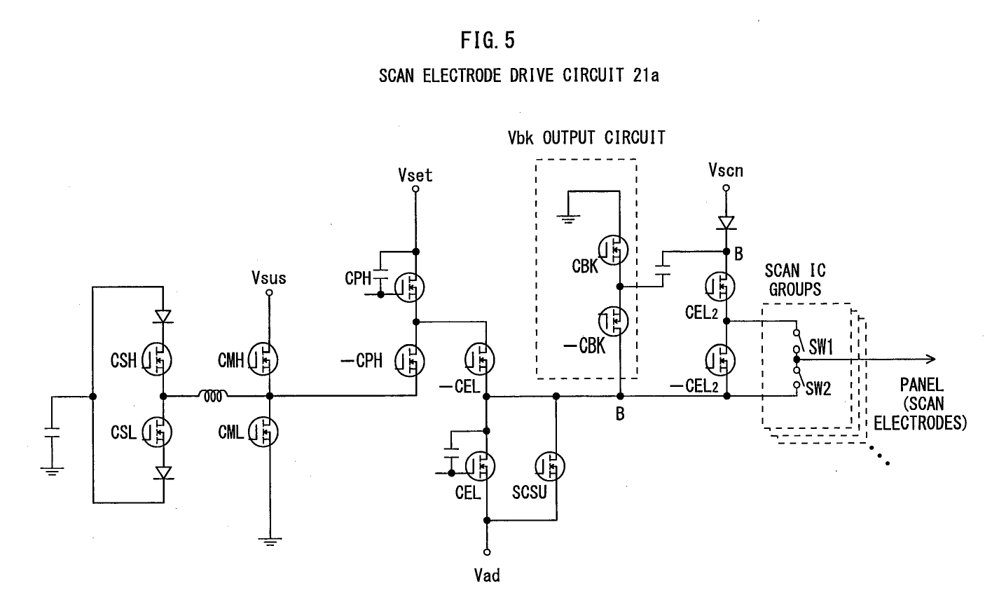

In the scan electrode drive circuit 21, as shown in FIG. 5, a reduction in the number of components and circuit simplification can be achieved for the Vbk output circuit by substituting the Vbk output circuit (dotted line) with the positive power supply (voltage Vscn) for the scan pulse. Here, a scan electrode drive circuit 21a shown in FIG. 5 is substantially the same as the scan electrode drive circuit 21 except for the Vbk circuit.

Note that a reduction in the number of components and circuit simplification can be similarly achieved by using the Vbk output circuit as the power supply of the Vscn output circuit.

### <Sustain Electrode Drive Circuit 22>

FIG. 7 shows the sustain electrode drive circuit 22 which outputs the voltage Ve(V) in the reset period, the voltage Vsus(V) in the sustain period, and the voltage Ve+Ve2(V) in the address period.

In the sustain electrode drive circuit 22, a positive power supply (voltage Vsus) for the sustain pulse and two power supplies (voltages Ve and Ve2) in the Ve/Ve+Ve2 output circuit (dotted part) are connected to input terminals J11 to J13, respectively. Also, the sustain electrode drive circuit 22 is provided with switching elements UEL, −UEL, UEH, and a capacitor C2. If the switching element −UEL is turned ON, the capacitor C2 is recharged in the polarity shown in the figure. After that (t8 to t11, t19 to t22), while the switching element UEL is ON, a recharge voltage of the capacitor C2 is added to the voltage Ve2 and output to the point A.

Thus, the switching elements UEL, −UEL, and UEH are controlled with timings shown in FIG. 9 to charge and recharge the capacitor C2, thereby applying the voltage Ve, in the reset period, and the voltage (Ve+Ve2), in the address period, to the sustain electrodes at a predetermined timing, as understood from the waveform chart in FIG. 3.

### <Address Electrode Drive Circuit 23>

FIG. 8 shows the address electrode drive circuit 23 which applies a voltage to the address electrodes in the sustain erase period P13, all-cell reset period P11 and the like of SF1.

In the address electrode drive circuit 23, a power supply (voltage Vda) for the address pulse is connected to an internal terminal J21. Also, each address IC group is provided with the two switches Sw1 and Sw2 which are controlled based on the subfield data in accordance with the timing signal transmitted from the timing generation unit 24 at the timing shown in FIG. 9.

As a result, in the address period, an address pulse is applied to address electrodes selected out of the plurality of address electrodes based on the subfield data.

### <Adjustment of Address Discharge Based on Average Brightness Level (APL) of Image Data>

Although the above description does not include varying intensity of the sustain discharge in SF1 depending on the image data, the intensity can be varied based on the average brightness level of the image data detected by the APL detection unit 28.

For example, the following control can be performed: the APL detection unit 28 detects APL for each frame, and when the APL value is comparatively small, the voltage Vbk of the scan electrodes is adjusted to be lower to attach more importance to contrast, and when the APL value is comparatively large, the voltage Vbk of the scan electrodes is adjusted to be higher to attach more importance to a balance between the gradation and brightness. As a result, optimum gradation characteristics can be obtained in accordance with the brightness of the screen.

### Advantages of Present Embodiment

In the present embodiment, as shown in FIG. 3, the voltage Vbk applied to the scan electrodes in the sustain erase period P13 of SF1 is set to be lower than the voltage Vsus(V) applied to the scan electrodes and the sustain electrodes in the sustain period P23 of SF2. Because the lower the voltage Vbk is, the smaller the spread of the sustain discharge is, the brightness of the 1^{st} gradation level can be reduced by setting the voltage Vbk to be lower than the voltage Vsus.

Considering the balance between gradation levels and brightness, it is preferable to set the voltage Vbk such that the brightness of the 1st gradation level be approximately 1.05 cd/m² which is the intermediate brightness between the brightness of the 0^{th} gradation level (0.23 cd/m²) and of the 2^{nd} gradation level (1.88 cd/m²).

If the voltage of the scan electrodes in the sustain erase period P13 of SF1 is set to be the same as that of the voltage Vsus in the sustain period P23 of SF2, the brightness of the 1^{st} gradation level is approximately 1.55 cd/m². However, by setting the voltage Vbk of the scan electrodes in the sustain erase period P13 of SF1 to be an appropriate value that is lower than that of the voltage Vsus (for example, when the voltage Vsus is 180V, the voltage Vbk is set to 120V), the brightness of the 1^{st} gradation level can be suppressed to approximately 1.05 cd/m².

It should be noted that because a sustain discharge will not occur if the voltage Vbk is lowered below the firing voltage, it is preferable that the voltage Vbk be equal to or higher than the firing voltage. Also, when the voltage Vbk is lower than approximately 50% of the voltage Vsus, a reset error which considerably impairs the image quality is more likely to occur. Accordingly, it is preferable that the voltage Vbk be approximately 50% or more of the voltage Vsus.

On the other hand, if the voltage Vbk applied to the scan electrodes in the sustain erase period P13 is set low, a discharge delay increases in general, causing an insufficient sustain discharge, and as a result, a reset error is more likely to occur in the next all-cell reset period. In the present embodiment, the positive voltage Vda is applied to the address electrodes in the sustain erase period P13. This allows electrons to be easily extracted from the surface of the protective layer 18 of the front panel PA1, especially from the area where the sustain electrodes 19b are arranged.

In general, a sustain discharge occurs between the scan electrodes 19a and sustain electrodes 19b using electrons emitted from the surface of the protective layer 18 of the front panel PA1 as a pilot burner. Accordingly, when the electrons are easily extracted from the protective layer 18, as described above, even if the voltage Vbk applied to the scan electrodes 19a in the sustain erase period P13 is low, a stable discharge can be performed without suffering a large delay in discharge.

In other words, because the sustain discharge terminates normally and the wall discharge is accumulated normally, reset errors can be suppressed in the voltage rising period T11 in the all-cell reset period P11 in the next TV field.

As described above, in the present embodiment, the brightness of the 1^{st} gradation level is controlled to an appropriately low brightness, and at the same time, reset errors are suppressed, improving display performance in low gradation levels.

It should be noted that when the magnitude of the positive voltage applied to the address electrodes in the sustain erase period P13 of SF1 is 15 V or more, the sustain discharge occurs more easily, attaining the advantage of reducing reset errors.

Also, as shown in FIG. 3, in the present embodiment, the timing (t13) of the application of the positive voltage to the address electrodes in the sustain erase period P13 is later than the timing (t12) of the application to the scan electrodes. It is preferable that the time difference between these two timings be set to approximately 3.5 μs or less, as this allows the sustain discharge to occur satisfactorily and reset errors to be suppressed as well. Especially, it is more preferable that this time difference be set to approximately 2.0 μs. Furthermore, it is preferable that the duration (t13 to t14) of the application of the positive voltage to the address electrodes be set to greater than 0.5 μs, more preferably to be approximately 1.5 μs.

Also, in order to enable the sustain discharge to terminate normally, it is preferable that the timing (t15) of applying the positive voltage to the sustain electrodes in the selective reset period P21 of SF2 be set to after a lapse of at least 2 μs, most preferably approximately 10 μs, from the timing (t12) of applying the positive voltage to the scan electrodes in the sustain erase period P13 of SF1.

### Second Embodiment

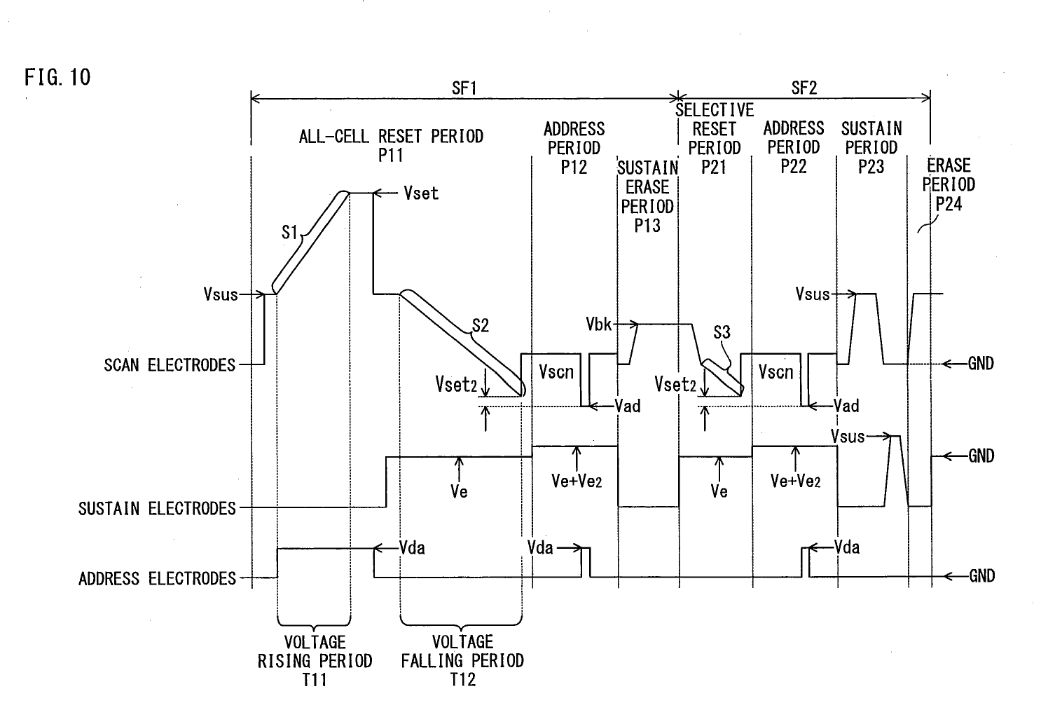

FIG. 10 shows drive voltage waveforms applied to the electrodes of the PDP of SF1 and SF2 by drive circuits of the present embodiment.

In the present embodiment, as in the first embodiment, the voltage Vbk applied to the scan electrodes in the sustain erase period P13 of SF1 is lower than the voltage Vsus applied to the scan electrodes and the sustain electrodes in the sustain period P23 of SF2. This weakens the sustain discharge of SF1, improving display performance in low gradation levels.

On the other hand, while, in the first embodiment, the voltage of the address electrodes is set to be at a positive voltage in the sustain erase period P13 of SF1 and at the ground voltage in the all-cell reset period P11 of SF1, in the present embodiment, the voltage of the address electrodes is set to be at the ground voltage in the sustain erase period P13 of SF1 and at a positive voltage in the voltage rising period T11 in the all-cell reset period P11 of SF1.

When the address electrodes are kept at a positive voltage in the voltage rising period T11, as described above, the voltage difference between the scan electrodes and address electrodes become smaller. Consequently, even in the discharge cells where the sustain discharge was not sufficiently generated in SF1, a weak discharge between the scan electrodes 19a and address electrodes 14 will not start, thereby suppressing reset errors.

As is apparent from the above, although, unlike the first embodiment, being unable to suppress a delay in the sustain discharge in SF1, the present embodiment can suppress reset errors in the all-cell reset period P11 of SF1 of the next TV field.

### Third Embodiment

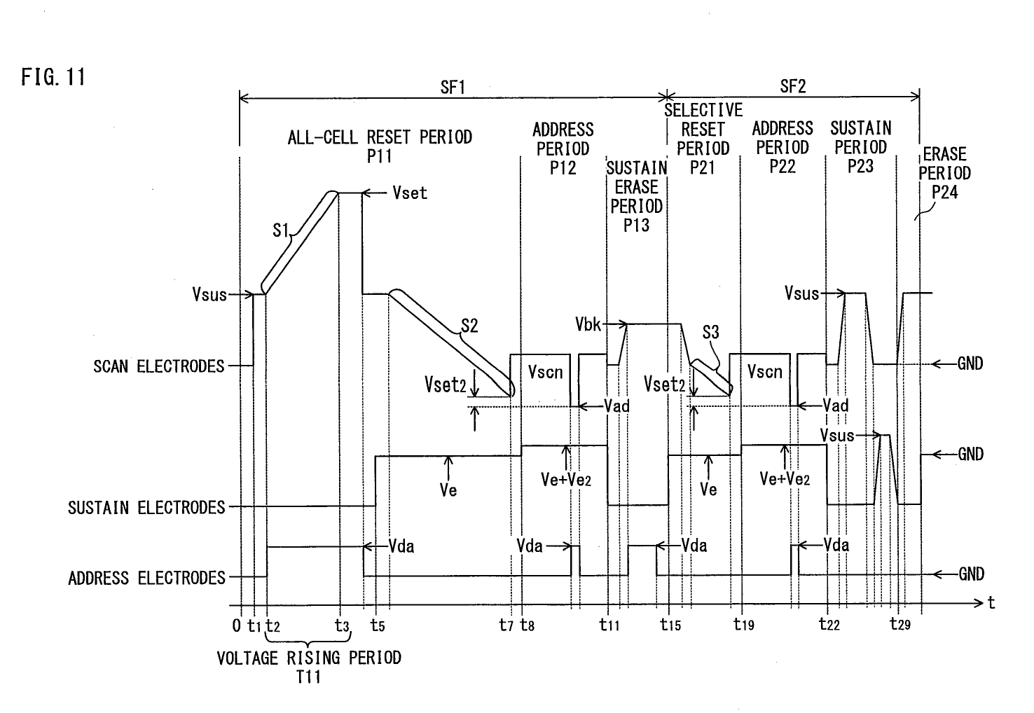

FIG. 11 shows drive voltage waveforms applied to the electrodes in the PDP in SF1 and SF2 by drive circuits of the present embodiment.

The present embodiment is a combination of the first and second embodiments, and sets (a) the voltage Vbk of the scan electrodes in the sustain erase period P13 of SF1 to be smaller than the voltage Vsus of the scan electrodes and the sustain electrodes in the sustain period P23 of SF2, and (b) the voltage of the address electrodes to be a positive voltage in the sustain erase period P23 of SF1 and in the voltage rising period T11 in the all-cell reset period P11.

Consequently, while weakening the sustain discharge in SF1 as in the first and second embodiments, the present embodiment further enables a more stable reset discharge compared to the first and second embodiments.

In other words, in the sustain erase period P13 of SF1, brightness of the sustain discharge is suppressed, and at the same time, the sustain discharge is terminated normally, thereby adjusting the wall charge to a desirable state. As a result, a weak discharge is unlikely to be generated between the scan electrodes and the address electrodes in the voltage rising period T11 in the all-cell reset period P11.

Additionally, as a result of keeping the address electrodes at a positive voltage in the voltage rising period T11 in the next all-cell reset period P11, a voltage difference between the scan electrodes and address electrodes becomes smaller also in discharge cells in which the address discharge was not generated. This suppresses a weak discharge from being started between the scan electrodes and the address electrodes.

### Fourth Embodiment

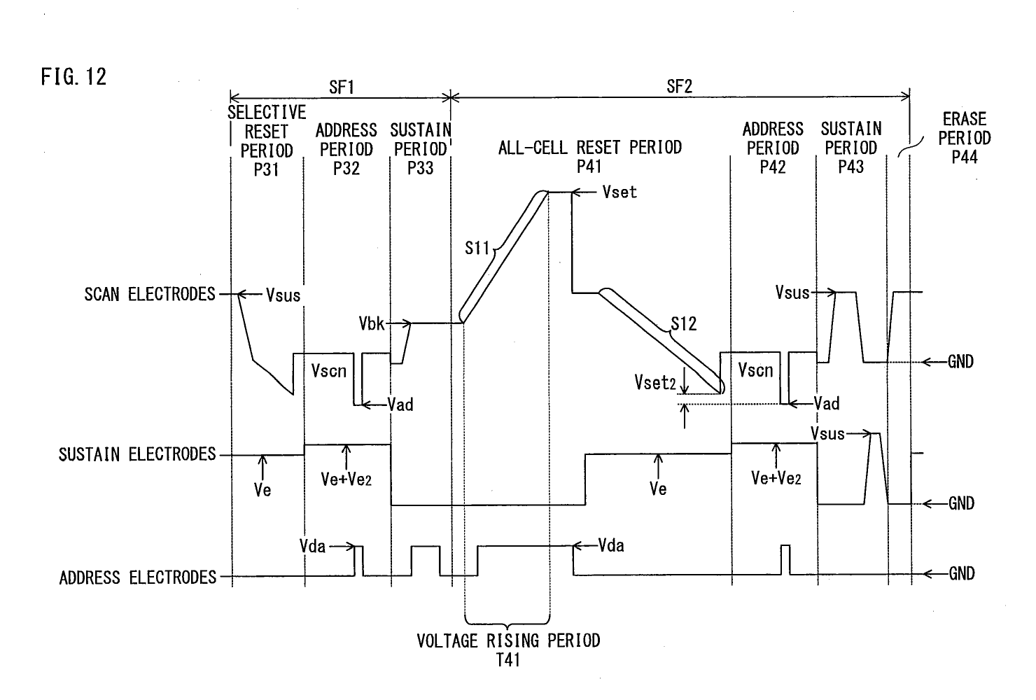

FIG. 12 shows drive voltage waveforms applied to the electrodes of the PDP in SF1 and SF2 by drive circuits of the fourth embodiment.

In the present embodiment, as in the third embodiment, the voltage Vbk applied to the scan electrodes in the sustain period P33 of SF1 is set to be lower than the voltage Vsus applied to the scan electrodes and the sustain electrodes in the sustain period P43 of SF2, and in addition, a positive voltage is applied to the address electrodes, in SF1, in the sustain P33 and voltage rising period T41 in the all-cell reset period P41. As a result, the sustain discharge in SF1 is weakened, and a stable reset discharge can be performed.

It should be noted that the effect of stabilizing the reset discharge can be achieved by applying a positive electrode to the address electrodes either in the sustain period P33 of SF1 or in the voltage rising period T41 in the all-cell reset period P41 of SF2.

Meanwhile, in the present embodiment, unlike the first to third embodiments, SF1 include a selective reset period P31, and SF2 includes an all-cell reset period P41. Consequently, a more stable address discharge can be performed in the address period P42 of SF2 compared to the first to third embodiments.

In general, if a sustain discharge is not generated repeatedly in the sustain period, a wall charge is not sufficiently accumulated. As a result, an erase discharge does not occur, and accordingly, a false discharge may occur in an address operation in the next SF. Especially in the present embodiment where the sustain discharge is generated only once in the sustain period P33 of SF1, a difference between the wall charge amount of the discharge cells in where the address discharge was generated and that of the discharge cells where the address discharge was not generated is considerably large at the end of SF1. However, because SF2 includes the all-cell reset period P31, the wall charge amount in each discharge cell is equalized before the address operation in SF2. Accordingly, in SF2, narrowing of a drive margin such as a smaller setting range of the driving voltage can be prevented.

It should be noted that although SF1 does not include an all-cell reset period in the present embodiment, it will not cause a problem, since the wall discharge formed during the all-cell reset in SF2 of the previous TV field which immediately precedes SF1 or the wall charge formed during the selective reset in SF3 or SF after that of the previous TV field is maintained.

Also, in view of obtaining the above-mentioned effect, it is preferable that an all-cell reset be performed in SF2 immediately after SF1. However, an all-cell reset can be performed in SF3 or after that.

### Fifth Embodiment

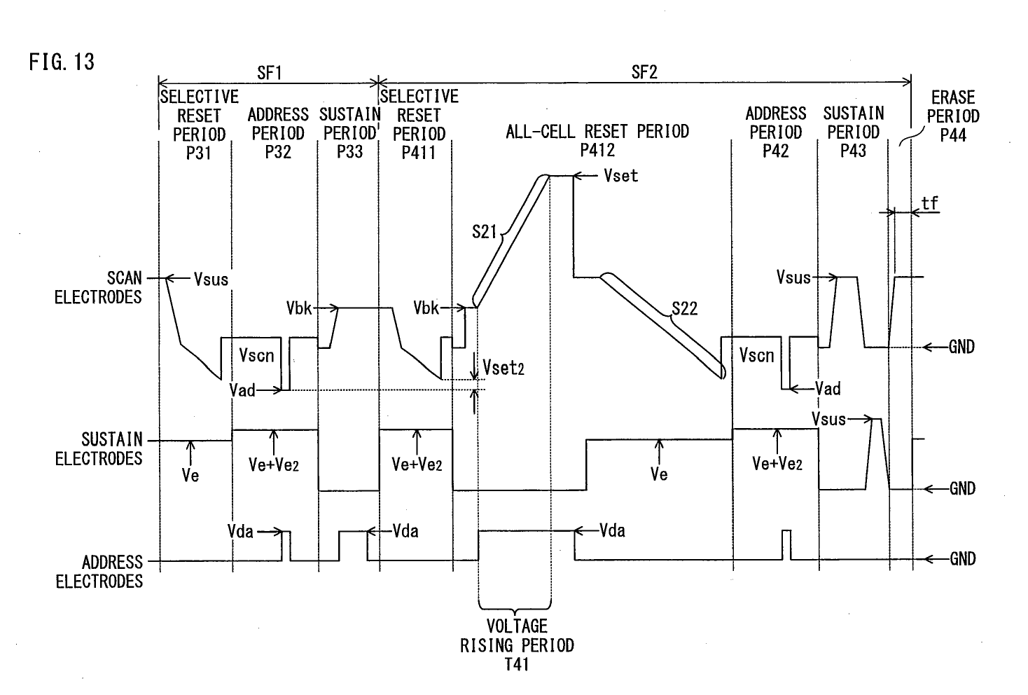

FIG. 13 shows drive voltage waveforms applied to the electrodes of the PDP in SF1 and SF2 by drive circuits of the present embodiment.

In the fourth embodiment, the all-cell reset period P41 of SF2 immediately followed the sustain period P33 of SF1 (see FIG. 12). As opposed to this, the drive voltage waveforms of the present embodiment include, after the sustain period P33 of SF1, a selective reset period P411 of SF2, and after that, includes an all-cell reset period P412.

The present embodiment attains the effects and advantages attained by the fourth embodiment, and in addition, is able to realizes an even more stable all-cell reset discharge.

Specifically, when the all-cell reset period P41 is provided immediately after the sustain period P33 of SF1, as in the fourth embodiment, in the discharge cells in which the address discharge was generated in SF1, the all-cell reset discharge is generated in the all-cell reset period P41 with the wall charge remaining from the end of the generation of the sustain discharge. On the other hand, in the discharge cells in which no address discharge was generated, the all-cell reset discharge is generated with the wall charge formed in the all-cell reset in the previous TV field or the wall charge remaining from the selective reset.

Accordingly, the state of the wall charge before the all-cell reset period P41 of SF2 differs between the discharge cells in which the address discharge was generated in SF1 and the discharge cells in which the address discharge was not generated. Consequently, a weak discharge in the all-cell reset period P41 is generated differently, being unable to uniformly generate the all-cell reset discharge in all of the discharge cells.

Further, after the sustain discharge in the sustain period P33 of SF1, a negative charge is accumulated on the scan electrodes, and a positive charge is accumulated on the sustain electrodes. Consequently, the all-reset discharge may not be generated in all of the discharge cells in the voltage rising period T41 in the all-cell reset period P412 of SF2.

As opposed to this, in the present embodiment, the state of the wall discharge in the discharge cells in which the address discharge was generated can be adjusted to be equivalent to that in the discharge cells in which the address discharge was not generated. This is because, as shown in FIG. 13, the selective reset period P411 is provided in SF2 immediately after the sustain period P33 of SF1. In other words, variation in the state of the wall charge from one discharge cell to another can be suppressed. After that, due to the presence of the all-cell reset period P412, a weak discharge is generated in each of the discharge cells irrespective of whether an address discharge has occurred or not therein.

Also, in the present embodiment, the weak discharge in the selective reset period P411 of SF2 provides a priming effect, allowing the weak discharge in the next all-cell reset period P412 to be generated easily.

It should be noted that the voltage Vset applied to the scan electrodes in the all-cell reset period P412 can be reduced by applying a positive voltage to the address electrodes in the selective reset period P411 of SF2 to enhance a weak discharge between the address electrodes and scan electrodes, thereby accumulating a negative charge on the address electrodes.

### <Confirmatory Experiment in Present Embodiment>

While the drive method of the present embodiment is applied, brightness in SF1 was measured to observe the occurrence of reset errors.

In this experiment, a PDP with an Xe ratio of 6% was used, and the respective voltage values were as follows: Vset=225 V, Vad=90 V, Vset2=5 V, Vscn=130 V, Vsus=180 V, Ve=155 V, Ve2=5 V, and Vda=75 V. Additionally, in the sustain period P33 of SF1, the voltage of the sustain electrodes was kept constant at the ground voltage, and the voltage Vbk of the scan electrodes was varied in a range of 0 to 180 V.

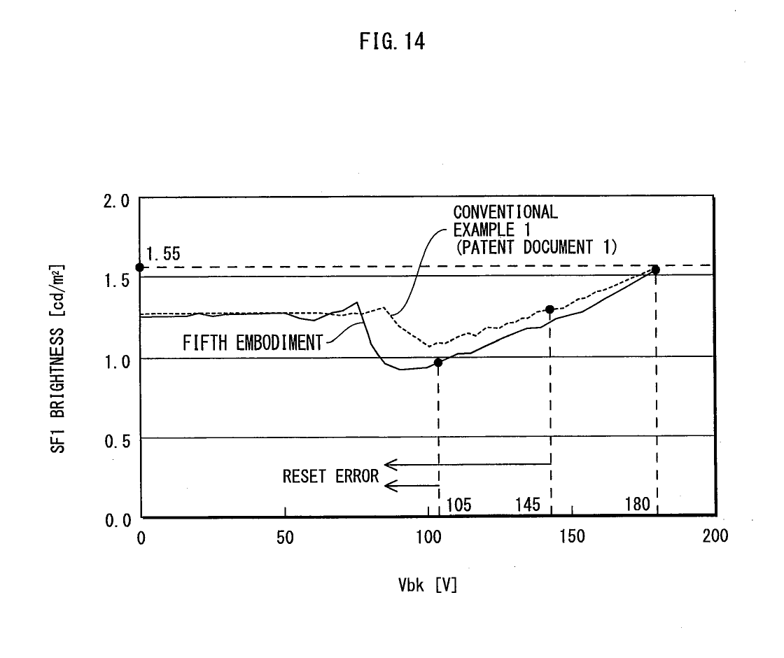

The measurement result is shown in FIG. 14 which is a characteristic chart showing the relationship between the voltage Vbk and the brightness in SF1.

As shown in FIG. 14, as the value of the voltage Vbk is lowered from 180 V to 90 V, the brightness in SF1 decreases. Specifically, the brightness is 1.55 cd/m² at 180 V, 0.96 cd/m² at 105 V, and 0.90 cd/m² at 90 V. Note that while the voltage Vbk is lowered from 105 V to 90 V, although a reset error occurs at other than observation points due to variation within the panel surface, the brightness lowers. However, when the voltage is 90 V or below, a reset error occurs at observation points, and the brightness rises.

As a comparative experiment, a similar experiment was conducted using the drive method based on the prior art (Patent Document 1), and the obtained result is shown as the dotted line in FIG. 14. According to this prior art, the brightness in SF1 is in a range of 1.08 to 1.55 cd/m², and a reset error occurs when the voltage Vbk is below 145 V (the brightness is 1.29 cd/m²).

It is apparent from the above that while the drive method of the prior art cannot reduce the brightness of the 1^{st} gradation level down to 1.05 cd/m² (approximately the intermediate brightness between the 0^{th} and 2^{nd} gradation levels), the drive method of the present embodiment can apply the voltage Vbk of 105 V to 145 V without causing a reset error, and realizes a preferable value for the brightness of the 1^{st} gradation level when Vbk is 120 V.

It should be noted that while the above confirmatory experiment was conducted with the PDP with the Xe ratio of 6%, if a PDP or a high-definition PDP having a high partial pressure of Xe (for example, Xe ratio of 65%) in the discharge gas is used instead, each voltage will increase by one to two times.

When the voltage Vda applied to the address electrodes in the sustain period P33 of SF1 and in the voltage rising period T41 in the all-cell reset period P412 is set to 15 V or higher, the sustain discharge is easily generated, and reset errors are reduced as a result. In addition, it is preferable that the voltage Vda be 150 V or lower. This is because when the voltage Vda is 150 V or higher, the voltage difference between the address electrodes and the sustain electrodes becomes too large, resulting in generation of a discharge between these electrodes.

The voltage Vda in the sustain period P33 and the voltage Vda in the voltage rising period T41 can be of different magnitudes. However, setting the voltage Vda (75 V) to a constant magnitude, as shown in the waveforms in FIG. 13, eliminates a need for a new power supply, allowing a simpler circuit structure.

The following should be noted: in FIG. 13, the voltage of the sustain electrodes in the sustain period P33 of SF1 is the ground voltage; however, if the voltage of the sustain electrodes is set to be lower than the ground voltage, that is to say, to a negative voltage, the sustain discharge is generated even more easily. Also, in the voltage rising period T41 in the all-cell reset period P412, setting the voltage of the sustain electrodes to be a negative voltage further reduces reset errors.

### Sixth Embodiment

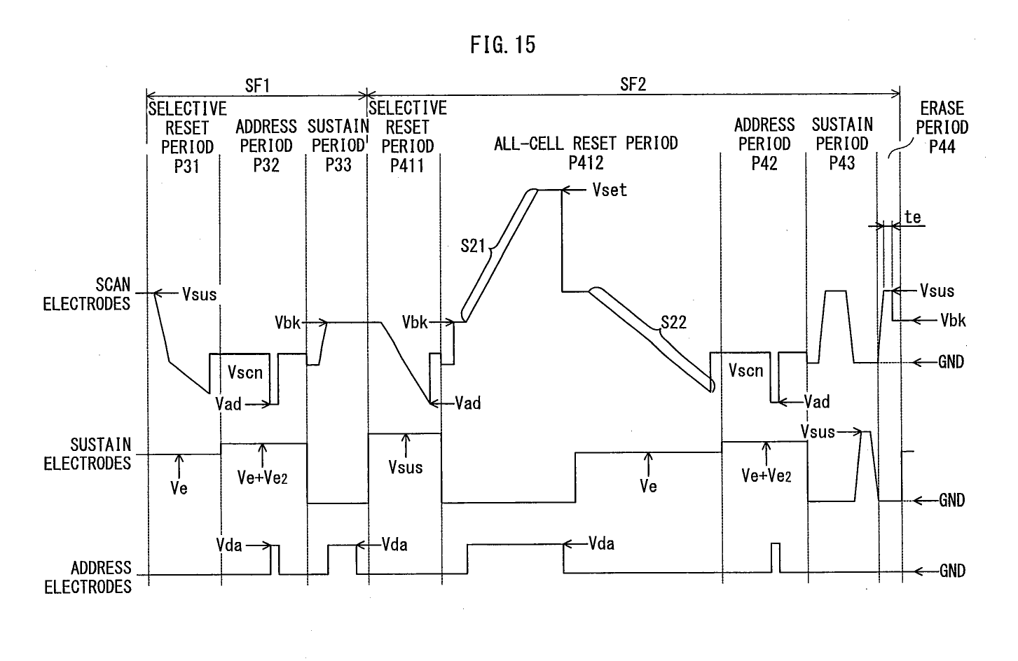

FIG. 15 shows drive voltage waveforms applied to the electrodes of the PDP in SF1 and SF2 by drive circuits of a sixth embodiment.

In the fifth embodiment, as shown in FIG. 13, the most negative voltage (voltage Vad(V)) applied to the scan electrodes in the selective reset period P411 of SF2 is the same as the most negative voltage applied to the scan electrodes in the selective reset period P31 of SF1. As opposed to this, in the present embodiment, the most negative voltage (voltage Vad(V)) applied to the scan electrodes in the selective reset period P411 of SF2 is lower by the voltage Vset2(V) than the most negative voltage applied to the scan electrodes in the selective reset period P411 of SF2 in the fifth embodiment. Accordingly, the most negative voltage (voltage Vad(V) applied to the scan electrodes in the selective reset period P411 of SF2 is lower than the most negative voltage applied to the scan electrodes in the selective reset period of any subfields other than SF2.

Also, while, in the fifth embodiment, the voltage applied to the sustain electrodes in the selective reset period P411 of SF2 is Ve+Ve2(V), in the present embodiment, the voltage Vsus(V) applied to the sustain electrodes in the selective reset period P411 of SF2 is higher than this voltage (Ve+Ve2(V)). Accordingly, the voltage (Vsus(V)) applied to the sustain electrodes in the selective reset period P411 of SF2 is higher than a voltage applied to the sustain electrodes in the selective reset period of any subfield other than SF2.

Further, in the present embodiment, unlike in the fifth embodiment, the voltage applied to the scan electrodes in the erase period P44 of SF2 rises to Vsus first and then falls to Vbk.

In the present embodiment, voltage differences among the three kinds of electrodes (scan electrode, sustain electrode, and address electrode) in the selective reset period P411 of SF2 are larger than in the fifth embodiment.

As a result of the increase in the voltage differences among the three kinds of electrodes, a weak discharge starts in the selective reset period P411 of SF2 in the discharge cells in which an address discharge was not generated. Consequently, variation in the state of wall charge between the discharge cells with an address discharge generated therein and the discharge cells without an address discharge can be eliminated nearly entirely.

Accordingly, the all-cell reset in the next all-cell reset period P412 is performed with almost no variation present among the discharge cells. This improves uniformity in the state of the wall charge in all the discharge cells and prevents write errors.

Also, in the present embodiment, a width te of an erase pulse (voltage Vsus) applied in the erase period P44 of SF2 is narrower than a width tf of an erase pulse applied in the erase period 44 in the fifth embodiment (see FIG. 13), thereby allowing the erase discharge to be terminated earlier than in the fifth embodiment. Consequently, a wall charge is not excessively accumulated during a selective reset in SF3, suppressing false discharges (crosstalk, etc.) in the subsequent address period of SF3.

In other words, the present embodiment enables an even more stable reset than the fifth embodiment, and in addition, is able to increase an erase margin.

The width te of the erase pulse is set to be a period which is not long enough for the wall charge to be stably accumulated by the erase discharge. Also, although the voltage Vbk is applied to the scan electrodes after applying the erase pulse of the width te at the voltage Vsus, the sustain discharge can be stopped, without applying this erase pulse, by applying the voltage Ve to the sustain electrodes after generating the sustain discharge at the voltage Vbk.

It should be noted that in FIG. 15, in the selective reset period P411 of SF2, although the address electrodes are kept at the ground voltage, a positive voltage can be applied to the address electrodes instead. This causes a weak discharge to be generated between the address electrodes and scan electrodes, thereby accumulating a negative charge on the address electrodes. As a result, the positive voltage Vset applied in the all-cell reset period P412 can be set lower accordingly.

### Seventh Embodiment

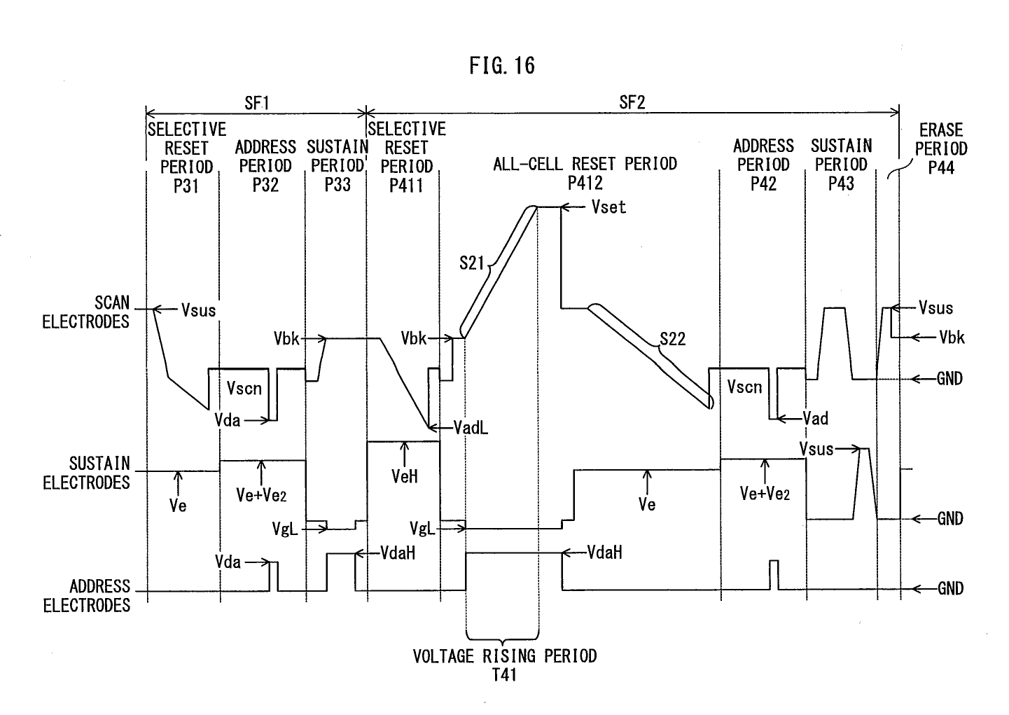

FIG. 16 shows drive voltage waveforms applied to the electrodes of the PDP in SF1 and SF2 by drive circuits of a seventh embodiment.

In the present embodiment, in the sustain period P33 of SF1, a positive voltage VdaH applied to the address electrodes is equal to or higher than the voltage Vda, and at the same time, a negative voltage (potential) VgL is applied to the sustain electrodes. In addition, in the selective reset period P411 of SF2, a voltage VeH (potential) applied to the sustain electrodes is equal to or higher than the voltage Vsus, and the most negative voltage VadL applied to the scan electrodes is equal to or lower than the voltage Vad. Furthermore, in the voltage rising period T41 in the all-cell reset period P412 of SF2, the negative voltage VgL is applied to the sustain electrodes, and the positive voltage VdaH equal to or higher than the voltage Vda is applied to the address electrodes.

In the present embodiment, as in the fourth and fifth embodiments, display performance in low gradation levels is improved. However, the display performance is improved further as a result of the application of the negative voltage VgL to the sustain electrodes and the application of the positive voltage VdaH equal to or higher than the voltage Vda to the address electrodes.

That is to say, in the sustain period P33 of SF1, even if a voltage applied to the scan electrodes is small, a sufficient sustain discharge can be generated. Also, compared with the sixth embodiment, the voltage difference between the scan electrodes and the sustain electrodes is larger, facilitating a discharge between the scan electrodes and the sustain electrodes.

Similarly, in the selective reset period P411 of SF2, the voltage difference between the scan electrodes and the sustain electrodes is larger than in the sixth embodiment. Consequently, the state of the wall charge in the discharge cells which had an address discharge generated in SF1 is brought closer to the state of the discharge cells which did not have an address charge, equalizing the state of the wall charge.

Further, also in the rising voltage period T41 in the all-cell reset period P412, the voltage difference between the scan electrodes and sustain electrodes becomes larger than in the sixth embodiment, facilitating the start of a weak discharge between the scan electrodes and the scan electrodes, and reducing reset errors.

It should be noted that according to the example in FIG. 16, in the selective reset period P411, the voltage VadL is applied to the scan electrodes and the voltage VeH is applied to the sustain electrodes, and in the voltage rising period T41 in the all-cell reset period P412, the voltage VgL is applied to the sustain electrodes and the voltage VdaH is applied to the address electrodes. However, not all of these applications need to be performed. One or more among these applications can enhance the effect of reducing reset errors.

In order to realize the above-described applications of voltages, which are different from those in the sixth embodiment in magnitude, to the electrodes in the sustain period P33 of SF1 and the selective reset period P411 and the all-cell reset period P412 of SF2, output power supplies and output circuits for these voltages are provided in the drive circuits. For example, in the address electrode drive circuit, a power supply for the voltage VdaH in addition to the power supply for the voltage Vda, a switching element for controlling the output of the power supply for the voltage VdaH, a switching element for controlling the output of the voltage VdaH and the like are provided to realize the drive voltage waveform shown in FIG. 16.

### INDUSTRIAL APPLICABILITY

The present invention can improve low gradation expression of PDP devices, which is considered inferior to that of CRTs, thereby contributing to an improvement in display quality of PDP devices.

1. A driving method for a plasma display panel which includes (i) a first substrate having a plurality of electrode pairs each composed of a first electrode and a second electrode and (ii) a second substrate having a plurality of third electrodes, the first substrate and the second substrate opposing each other in a manner that the third electrodes spatially intersect the electrode pairs, whereby discharge cells are constituted at intersections of the electrode pairs and the third electrodes, wherein the driving of the plasma display panel comprises:
one TV field is composed of a plurality of subfields each including a reset period in which a reset discharge is generated in the discharge cells, an address period in which an address discharge is generated in discharge cells to be lit, and a sustain period in which a sustain discharge is generated in the discharge cells in which the address discharge was generated,
in a sustain period of, among the plurality of subfields, a subfield having a smallest brightness weight, a positive voltage is applied to the first electrodes, the positive voltage being smaller than a voltage applied to the first electrodes in a sustain period of any of the plurality of subfields other than the subfield having the smallest brightness weight,
a reset period of a subfield immediately after the subfield having the smallest brightness weight includes (a) a selective reset period including a voltage falling period in which the voltage of the first electrodes falls in a ramp shape at a voltage gradient of 10 V/μs or less, and
a most negative voltage applied to the first electrodes in the selective reset period is lower than any voltage applied to the first electrodes in a selective reset period for any of the plurality of subfields other than the subfield immediately after the subfield having the smallest brightness weight.

2. A driving method for a plasma display panel which includes (i) a first substrate having a plurality of electrode pairs each composed of a first electrode and a second electrode and (ii) a second substrate having a plurality of third electrodes, the first substrate and the second substrate opposing each other in a manner that the third electrodes spatially intersect the electrode pairs, whereby discharge cells are constituted at intersections of the electrode pairs and the third electrodes, wherein the driving of the plasma display panel comprises:
one TV field is composed of a plurality of subfields each including a reset period in which a reset discharge is generated in the discharge cells, an address period in which an address discharge is generated in discharge cells to be lit, and a sustain period in which a sustain discharge is generated in the discharge cells in which the address discharge was generated,
in a sustain period of, among the plurality of subfields, a subfield having a smallest brightness weight, a positive voltage is applied to the first electrodes, the positive voltage being smaller than a voltage applied to the first electrodes in a sustain period of any of the plurality of subfields other than the subfield having the smallest brightness weight,
a reset period of a subfield immediately after the subfield having the smallest brightness weight includes (a) a selective reset period including a voltage falling period in which a voltage of the first electrodes falls in a ramp shape at a voltage gradient of 10 V/μs or less and (b) an all-cell reset period including a voltage rising period in which the voltage of the first electrodes rises in a ramp shape at a voltage gradient of 10 V/μs or less, and
a most positive voltage applied to the second electrodes in the selective reset period is higher than any voltage applied to the second electrodes in a selective reset period for any of the plurality of subfields other than the subfield immediately after the subfield having the smallest brightness weight.

3. The driving method for the plasma display panel of claim 2, wherein
in the sustain period of the subfield having the smallest brightness weight, a positive voltage is applied to the third electrodes.

4-30. (canceled)

31. The driving method for the plasma display panel of claim 1, wherein
in the sustain period of the subfield having the smallest brightness weight, a positive voltage is applied to the third electrodes.

32. The driving method for the plasma display panel of claim 1, wherein
in at least part of the voltage rising period, a positive voltage is applied to the third electrodes.

33. The driving method for the plasma display panel of claim 2, wherein
in at least part of the voltage rising period, a positive voltage is applied to the third electrodes.

34. The driving method for the plasma display panel of claim 1, wherein
a negative voltage is applied to the second electrodes in the sustain period of the subfield having the smallest brightness weight.

35. The driving method for the plasma display panel of claim 2, wherein
a negative voltage is applied to the second electrodes in the sustain period of the subfield having the smallest brightness weight.

36. The driving method for the plasma display panel of claim 1, wherein
the positive voltage applied to the third electrodes in the sustain period of the subfield having the smallest brightness weight is higher than a voltage applied to the third electrodes in the address period of the subfield having the smallest brightness weight.

37. The driving method for the plasma display panel of claim 2, wherein
the positive voltage applied to the third electrodes in the sustain period of the subfield having the smallest brightness weight is higher than a voltage applied to the third electrodes in the address period of the subfield having the smallest brightness weight.

38. The driving method for the plasma display panel of claim 1, wherein
a negative voltage is applied to the second electrodes in the voltage rising period.

39. The driving method for the plasma display panel of claim 2, wherein
a negative voltage is applied to the second electrodes in the voltage rising period.

40. The driving method for the plasma display panel of claim 1, wherein
the positive voltage applied to the third electrodes in the voltage rising period is higher than a voltage applied to the third electrodes in the address period of the subfield which includes the voltage rising period.

41. The driving method for the plasma display panel of claim 2, wherein
the positive voltage applied to the third electrodes in the voltage rising period is higher than a voltage applied to the third electrodes in the address period of the subfield which includes the voltage rising period.

42. The driving method for the plasma display panel of claim 1, wherein
an average brightness level of image data is detected for each TV field, and a magnitude of the positive voltage applied to the first electrodes in the sustain period of the subfield having the smallest brightness weight is adjusted based on the detected average brightness level.

43. The driving method for the plasma display panel of claim 2, wherein
an average brightness level of image data is detected for each TV field, and a magnitude of the positive voltage applied to the first electrodes in the sustain period of the subfield having the smallest brightness weight is adjusted based on the detected average brightness level.

44. The driving method for the plasma display panel of claim 1, wherein
the positive voltage applied to the first electrodes in the sustain period of the subfield having the smallest brightness weight is in a range of 90 V to 180 V, inclusive.

45. The driving method for the plasma display panel of claim 2, wherein
the positive voltage applied to the first electrodes in the sustain period of the subfield having the smallest brightness weight is in a range of 90 V to 180 V, inclusive.

46. The driving method for the plasma display panel of any of claim 1, wherein
the positive voltage applied to the third electrodes is in a range of 15 V to 150 V, inclusive.

47. The driving method for the plasma display panel of any of claim 1, wherein
the positive voltage applied to the third electrodes is in a range of 15 V to 150 V, inclusive.

48. The driving method for the plasma display panel of claim 1, wherein
the positive voltage applied to the first electrodes in the sustain period of the subfield having the smallest brightness weight is in a range of 50% to 100%, inclusive, of the voltage applied to the first electrodes in the sustain period of any of the plurality of subfields other than the subfield having the smallest brightness weight.

49. The driving method for the plasma display panel of claim 1, wherein
the positive voltage applied to the first electrodes in the sustain period of the subfield having the smallest brightness weight is in a range of 50% to 100%, inclusive, of the voltage applied to the first electrodes in the sustain period of any of the plurality of subfields other than the subfield having the smallest brightness weight.

50. A plasma display panel device comprising:
a plasma display panel; and
a drive unit which drives the plasma display panel to display images, the plasma display panel including (i) a first substrate having a plurality of electrode pairs each composed of a first electrode and a second electrode and (ii) a second substrate having a plurality of third electrodes, the first substrate and the second substrate opposing each other in a manner that the third electrodes intersect the electrode pairs three-dimensionally, whereby discharge cells are constituted at intersections of the electrode pairs and the third electrodes, wherein
one TV field is composed of a plurality of subfields each including a reset period in which a reset discharge is generated in the discharge cells, an address period in which an address discharge is generated in discharge cells to be lit, and a sustain period in which a sustain discharge is generated in the discharge cells in which the address discharge was generated,
the drive unit applies, in a sustain period of, among the plurality of subfields, a subfield having a smallest brightness weight, a positive voltage to the first electrodes, the positive voltage being smaller than a voltage applied to the first electrodes in a sustain period of any of the plurality of subfields other than the subfield having the smallest brightness weight,
a reset period of a subfield immediately after the subfield having the smallest brightness weight includes (a) a selective reset period including a voltage falling period in which a voltage of the first electrodes falls in a ramp shape at a voltage gradient of 10 V/μs or less and (b) an all-cell reset period including a voltage rising period in which the voltage of the first electrodes rises in a ramp shape at a voltage gradient of 10 V/μs or less, and
a most negative voltage applied to the first electrodes in the selective reset period is lower than any voltage applied to the first electrodes in a selective reset period for any of the plurality of subfields other than the subfield immediately after the subfield having the smallest brightness weight.

51. A plasma display panel device comprising:
a plasma display panel;
and a drive unit which drives the plasma display panel to display images, the plasma display panel including (i) a first substrate having a plurality of electrode pairs each composed of a first electrode and a second electrode and (ii) a second substrate having a plurality of third electrodes, the first substrate and the second substrate opposing each other in a manner that the third electrodes intersect the electrode pairs three-dimensionally, whereby discharge cells are constituted at intersections of the electrode pairs and the third electrodes, wherein
one TV field is composed of a plurality of subfields each including a reset period in which a reset discharge is generated in the discharge cells, an address period in which an address discharge is generated in discharge cells to be lit, and a sustain period in which a sustain discharge is generated in the discharge cells in which the address discharge was generated,
the drive unit applies, in a sustain period of, among the plurality of subfields, a subfield having a smallest brightness weight, a positive voltage to the first electrodes, the positive voltage being smaller than a voltage applied to the first electrodes in a sustain period of any of the plurality of subfields other than the subfield having the smallest brightness weight,
a reset period of a subfield immediately after the subfield having the smallest brightness weight includes (a) a selective reset period including a voltage falling period in which a voltage of the first electrodes falls in a ramp shape at a voltage gradient of 10 V/μs or less and (b) an all-cell reset period including a voltage rising period in which the voltage of the first electrodes rises in a ramp shape at a voltage gradient of 10 V/μs or less, and
a most positive voltage applied to the second electrodes in the selective reset period is higher than any voltage applied to the second electrodes in a selective reset period for any of the plurality of subfields other than the subfield immediately after the subfield having the smallest brightness weight.

52. The plasma display panel device of claim 50, wherein
in the sustain period of the subfield having the smallest brightness weight, a positive voltage is applied to the third electrodes.

53. The plasma display panel device of claim 51, wherein
in the sustain period of the subfield having the smallest brightness weight, a positive voltage is applied to the third electrodes.

54. The plasma display panel device of claim 50, wherein
in at least part of the voltage rising period, a positive voltage is applied to the third electrodes.

55. The plasma display panel device of claim 51, wherein
in at least part of the voltage rising period, a positive voltage is applied to the third electrodes.

56. The plasma display panel device of claim 50, wherein
a negative voltage is applied to the second electrodes in the sustain period of the subfield having the smallest brightness weight.

57. The plasma display panel device of claim 51, wherein
a negative voltage is applied to the second electrodes in the sustain period of the subfield having the smallest brightness weight.

58. The plasma display panel device of claim 50, wherein
the positive voltage applied to the third electrodes in the sustain period of the subfield having the smallest brightness weight is higher than a voltage applied to the third electrodes in the address period of the subfield having the smallest brightness weight.

59. The plasma display panel device of claim 51, wherein
the positive voltage applied to the third electrodes in the sustain period of the subfield having the smallest brightness weight is higher than a voltage applied to the third electrodes in the address period of the subfield having the smallest brightness weight.

60. The plasma display panel device of claim 50, wherein
in at least part of the voltage rising period, a negative voltage is applied to the second electrodes.

61. The plasma display panel device of claim 51, wherein
in at least part of the voltage rising period, a negative voltage is applied to the second electrodes.

62. The plasma display panel device of claim 50, wherein
in at least part of the voltage rising period, the positive voltage applied to the third electrodes is higher than a voltage applied to the third electrodes in the address period of the subfield which includes the voltage rising period.

63. The plasma display panel device of claim 51, wherein
in at least part of the voltage rising period, the positive voltage applied to the third electrodes is higher than a voltage applied to the third electrodes in the address period of the subfield which includes the voltage rising period.

64. The plasma display panel device of claim 50, wherein
an average brightness level of image data is detected for each TV field, and a magnitude of the positive voltage applied to the first electrodes in the sustain period of the subfield having the smallest brightness weight is adjusted based on the detected average brightness level.

65. The plasma display panel device of claim 51, wherein
an average brightness level of image data is detected for each TV field, and a magnitude of the positive voltage applied to the first electrodes in the sustain period of the subfield having the smallest brightness weight is adjusted based on the detected average brightness level.

66. The plasma display panel device of claim 50, wherein
the positive voltage applied to the first electrodes in the sustain period of the subfield having the smallest brightness weight is in a range of 90 V to 180 V, inclusive.

67. The plasma display panel device of claim 51, wherein
the positive voltage applied to the first electrodes in the sustain period of the subfield having the smallest brightness weight is in a range of 90 V to 180 V, inclusive.

68. The plasma display panel device of claim 50, wherein
the positive voltage applied to the third electrodes is in a range of 15 V to 150 V, inclusive.

69. The plasma display panel device of claim 51, wherein
the positive voltage applied to the third electrodes is in a range of 15 V to 150 V, inclusive.

70. The plasma display panel device of claim 50, wherein
the positive voltage applied to the first electrodes in the sustain period of the subfield having the smallest brightness weight is in a range of 50% to 100%, inclusive, of the voltage applied to the first electrodes in the sustain period of any of the plurality of subfields other than the subfield having the smallest brightness weight.

71. The plasma display panel device of claim 51, wherein
the positive voltage applied to the first electrodes in the sustain period of the subfield having the smallest brightness weight is in a range of 50% to 100%, inclusive, of the voltage applied to the first electrodes in the sustain period of any of the plurality of subfields other than the subfield having the smallest brightness weight.
